(19) United States
(12) Patent Application Publication
(10) Pub. No.: US 2024/0161310 A1
(43) Pub. Date: May 16, 2024

(54) Detecting and Tracking Cookware Items On A Cooking Surface

(71) Applicant: Samsung Electronics Co., Ltd., Suwon-si (KR)

(72) Inventors: William Augustus Workman, San Francisco, CA (US); Jun Yeon Cho, San Jose, CA (US); Yufeng Wu, Mountain View, CA (US); Eun Seo Cho, Mountain View, CA (US); Stefan van der Hoff, Sunnyvale, CA (US)

(21) Appl. No.: 17/987,859

(22) Filed: Nov. 16, 2022

(51) Int. Cl. G06T 7/246; A47J 36/32; G01J 5/08; G06T 5/00; G06T 7/30; G06T 7/73; G06V 10/143; G06V 10/74; G06V 20/52

(52) U.S. Cl. CPC G06T 7/246; A47J 36/32; G01J 5/0859; G06T 5/006; G06T 7/30; G06T 7/73; G06V 10/143; G06V 10/74; G06V 20/52; G01J 2005/0077

(57) ABSTRACT

In one embodiment, a method includes accessing an image of a cooking surface, where the image is associated with a field of view that includes the cooking surface. The method further includes identifying, based at least on the image, one or more cookware items within the field of view, associating a unique identifier with each identified cookware item in the field of view, and tracking, using one or more subsequent images of the cooking surface, a location of each of the one or more cookware items relative to the cooking surface.

### TECHNICAL FIELD

This application generally relates to detecting and tracking cookware items on a cooking surface.

### BACKGROUND

Kitchen appliances may include a cooking surface, such as a range on top of an oven. Directly (or approximately directly) above this surface is often mounted another appliance or electronic device, such as a microwave that contains a venting system or a range hood that vents exhaust from the cooking surface.

Cameras are a kind of sensor that typically detect some part of the spectrum of electromagnetic radiation within a field of view of the camera. The field of view defines the region in space in which the camera is able to detect images of its environment. Cameras can include optical sensors, such as a camera that senses radiation in the visible color spectrum. Cameras can also include thermal cameras, which typically detect radiation in the infrared spectrum, which can be used to determine the temperature of objects within the field of view of the thermal camera.

### BRIEF DESCRIPTION OF THE DRAWINGS

FIG. 1 illustrates an example method for detecting and tracking cookware items on a cooking surface.

FIG. 2 illustrates examples of information that can be identified and associated with a cookware item.

FIG. 3 illustrates an example approach for matching cookware items from a sequence of images.

FIG. 4 illustrates an example approach for handling removal of cookware items from the field of view or adding cookware items to the field of view.

FIG. 5 illustrates an example user interface for providing feedback to a user.

FIG. 6 illustrates an example computing device.

### DESCRIPTION OF EXAMPLE EMBODIMENTS

This disclosure describes systems and methods that automatically detect and track objects and events on a cooking surface, such as cooking events on an oven range. As explained more fully herein, these systems and methods detect, predict, track, and guide cooking processes in many different ways.

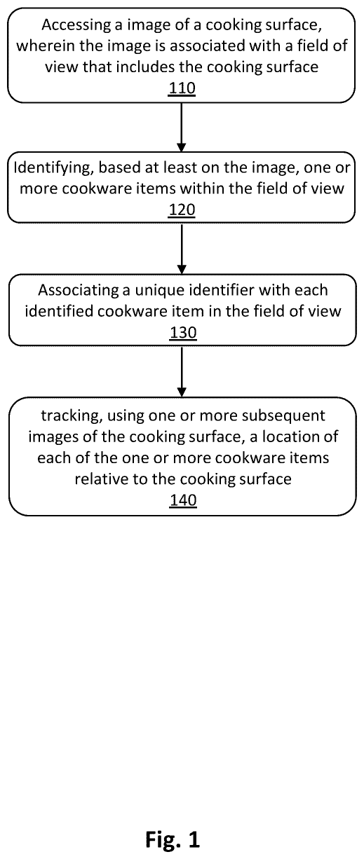

FIG. 1 illustrates an example method for detecting and tracking cookware items on a cooking surface. Step 110 of the example method of FIG. 1 includes accessing an image of a cooking surface, where the image is associated with a field of view that includes the cooking surface. In particular embodiments, accessing an image may include capturing the image, e.g., by an optical camera or a thermal camera, or both. In other embodiments, accessing the image may include retrieving the image from a memory of a computing device or receiving the image from a hardware component or over a data connection (such as a Wi-Fi connection) from another computing device.

In particular embodiments, the one or more cameras that capture images of the cooking surface may be integrated with a device placed directly above the cooking surface. For example, a range hood may include an optical camera, a thermal camera, and a computing device (such as a processor and memory) to capture images and perform the procedures discussed more fully herein. The device may also include software loaded onto a memory of the device, e.g., to perform the functions described herein such as detecting and tracking cookware items, detecting events, generating recipes, and providing output to a user. To provide output, the device may include one or more displays to provide visual output and/or one or more speakers to provide audio output. In particular embodiments, some of the hardware used to perform the methods and procedures described herein may be distributed between two or more devices. For example, computer processing hardware and the associated software may be located on a device, such as a mobile phone, personal computer, or server device, that is connected to a device such a range hood. For example, a range hood may include a processor that analyzes images, performs low-powered tasks such as undistortion and alignment, then sends the image to a paired computing device, such as smartphone, for object and event detection and tracking. As another example, in particular embodiments a connected device, such as a smartphone or smartwatch, can act as the external display and speaker to provide feedback to the user.

In particular embodiments, an image of a cooking surface may be an optical image of the cooking surface or a thermal image of the cooking surface. In particular embodiments, an image of the cooking surface may be a processed optical image or a processed thermal image that is processed by e.g., removing distortions from a raw image. In particular embodiments, an image may be an image that combines output from an optical camera and a thermal camera. For example, particular embodiments may access (which may include capturing) a thermal image from a thermal camera and an optical image, e.g., such as an RGB image or a grayscale image. Distortions may be removed from each of the thermal image and the optical image, for example by correcting for a “fish-eye” effect commonly found in cameras. The thermal and optical images may be aligned, for example so that the pixels in the thermal image correspond to the pixels in the optical image. Then, the two aligned images can be merged to create a single image, which may be a 4-channel image containing both RGB information (3 channels) and thermal information (1 channel). This merged image may then be accessed, such as in step 110 of the example method of FIG. 1, and subsequently used to perform the procedures described herein. In particular embodiments, an accessed image may be part of a real-time stream of images, or may be part of a previously recorded video feed or image stream.

Step 120 of the example method of FIG. 1 may include identifying, based at least on the image, one or more cookware items within the field of view. This disclosure contemplates that cookware items include any suitable cookware item, such as pots, pans, dishes, utensils (such as spatulas, spoons, etc.), lids, or any other suitable cookware item. In particular embodiments, identifying a cookware item may include detecting one or more features, from the accessed image, related to the cookware item. For example, the shape of a cookware item may be detected, for example by using a Hough circle-detection algorithm to detect a circular shape in the image, which may correspond to the shape of a circular pot or pan in the image. The Hough circle-detection algorithm is one example of an algorithm that can use as input a single channel, and therefore such algorithms can operate using, e.g., just a thermal image or a grayscale image. In particular embodiments, one or more machine-learning algorithms may be used to extract and detect features in an image. For example, the YOLO or SSD algorithms (each of which use convolutional neural networks) may be trained on a set of cookware items and then may be deployed to detect features in an image to detect cookware items in the image. In particular embodiments, machine-learning algorithms may use the full 4-channel information in a merged RGB and thermal image, or may use just RGB information in an RGB image or thermal information in a thermal image.

In particular embodiments, step 120 may include determining the location, e.g., relative to the cooking surface, of the identified cookware items in the image. For example, a location may be a location with respect to a coordinate system of the cooking surface or of the camera. As another example, a location may be a predetermined location with respect to the cooking surface, e.g., a determination that cookware item is on or near a particular heating element, such as a burner, of the cooking surface. For example, the location of burners on an oven range may be preloaded onto a system or predetermined by the system, and identified cookware items may be located with respect to this burner pattern. In particular embodiments, locating a cookware item may include locating that item with respect to another item. For example, a pan may be identified as located on a particular burner, while a spatula may be identified as located above that pan or near that pan. In particular embodiments, step 120 may include determining the size of the identified cookware items in the image. The size may be expressed in numerical terms or expressed in relative terms (e.g., a “large” class of pan vs. a “small” class of pan).

In particular embodiments, step 120 may include determining additional information about a cookware item, such as for example by extracting metadata about the item from the image accessed in step 110 of the example method of FIG. 1. For example, this information could include the average intensity of the colors of the cookware item, the type of cookware item (such as frying pan, stock pot, etc.), the orientation of the cookware item, location of features such as, e.g., handles, the current average temperature of the cookware item, content within the cookware item, detected brand of the cookware item, the size and locations of markings on the cookware item, and so on. As one example of the type of metadata detection that may be used, the accessed image may be cropped to include only the cookware items identified in the image. The cropped portions may be resized, and feature scaling may be applied. A machine-learning model such as a CNN followed by a linear predictor followed by a softmax function may be used to detect the type of cookware item, such as a pot, by classifying each identified cookware item.

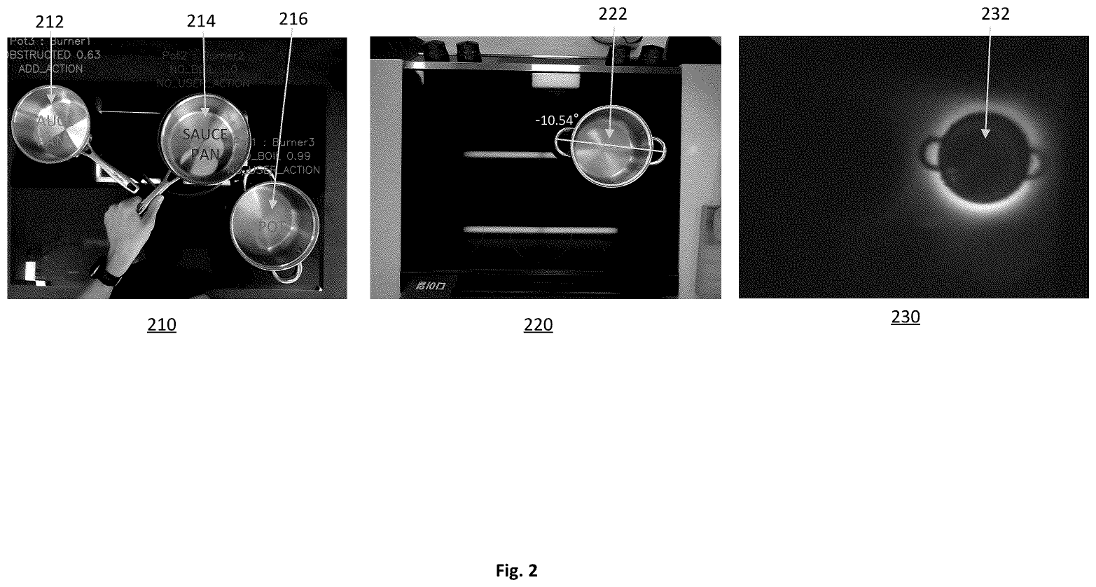

FIG. 2 illustrates examples of the kind of information that can be identified and associated with a cookware item. Each of images 210, 220, and 230 illustrate top-down images of a cooking surface, i.e., images taken by a camera that is pointing down at the cooking surface. Images 210 and 220 in FIG. 2 illustrate RGB images. In image 210, cookware items 212, 214, and 216 are each associated with a label and a location (i.e., a particular burner location). In image 220, cookware item 222 is identified by its orientation, using identified pots handles as a feature to determine orientation. Image 230 is a thermal image, and in image 230 cookware item 232 is identified by its average temperature and/or the average temperature of its contents. In addition, images 210, 220, and 230 each illustrate using a shape-detection algorithm to detect the circular shape of each pot in the images.

Step 130 of the example method of FIG. 1 includes associating a unique identifier with each identified cookware item in the field of view. In particular embodiments, the unique identifier may include the location of the cookware item. In particular embodiments, the unique identifier may include the size of the item. In particular embodiments, the unique identifier may be an identifier, such as a number, in a list or table of cookware items, as explained more fully herein. In particular embodiments, a unique identifier may include a label, or class, of cookware item, such as for example that the item is a “frying pan” or a “stock pot.” In particular embodiments, a unique identifier may include features or metadata about the cookware item, e.g., as determined in step 120 of the example method of FIG. 1. This disclosure contemplates that a unique identifier distinguishes cookware items in an image from each other, and may include or be associated with any suitable combination of information described herein.

Step 140 of the example method of FIG. 1 includes tracking, using one or more subsequent images of the cooking surface, a location of each of the one or more cookware items relative to the cooking surface. For example, a subsequent image may be another merged 4-channel image resulting from processing and merging images captured by an optical camera and a thermal camera integrated with a range hood. The cookware items in the subsequent image(s) may be identified as discussed above with respect to steps 120 and 130 of the example method of FIG. 1, and then the results from the image accessed in step 110 and from the subsequent image(s) are used to track at least the location of the cookware items relative to the cooking surface, which includes determining where the cookware item is with respect to the cooking surface (e.g., on the surface, off the surface, on a particular burner, at particular coordinates, etc.). In addition, as explained more fully herein, subsequent image(s) may be used to detect cooking events and provide output to a user.

In particular embodiments, cookware item identified in a particular image may be matched with cookware items previously detected during a particular cooking episode. A cooking episode may be defined by a user, e.g., by inputting that the user is beginning a new cooking episode using the cooking surface, or by a length of time since any activity was detected on the cooking surface. For example, if, e.g., 30 minutes has passed since any activity or cooking has been detected on the cooking surface, then any new activity may be associated with a new cooking episode.

In particular embodiments, determining matches between cookware items detected in two or more images during a cooking episode may be necessary to track the cookware items because cookware items identified in two different images may not otherwise be correlated. For example, the cookware items may be output in different orders after processing the images, and/or the locations of the cookware items may change between images, particularly if the image frame rate is relatively low, and/or the cookware items may enter and leave the field of view for significant periods of time.

In particular embodiments, cookware items may be matched based on features associated with the cookware item. For example, cookware items may be matched if they are identified as a pot or pan, or other receptacle for food items, but not matched if they are identified as, e.g., a utensil.

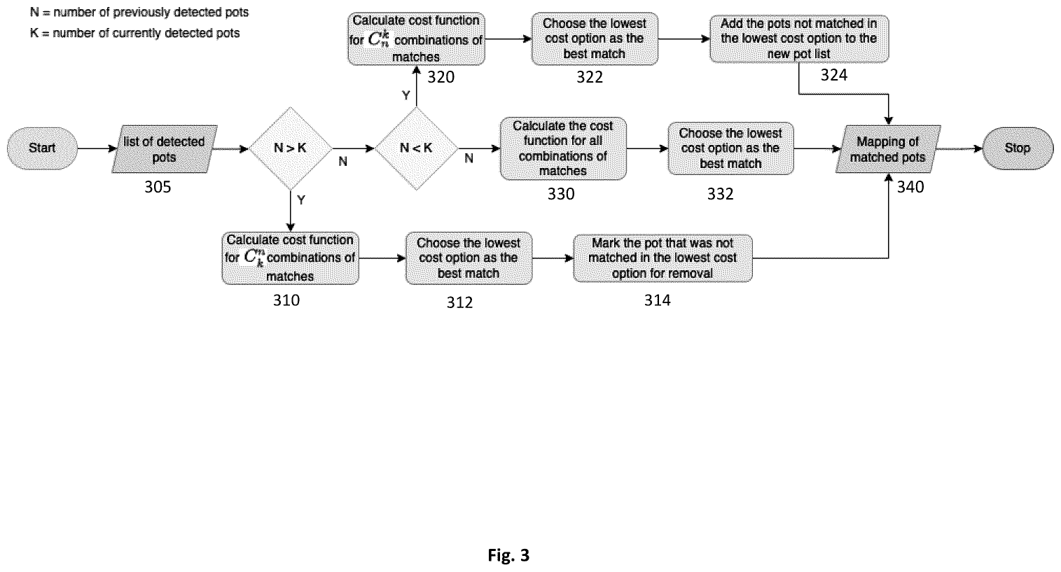

In particular embodiments, matching cookware items includes creating a list of items identified in at least one first image and a list of items identified in at least one second image. For example, the cookware items may be detected and uniquely identified (e.g., with a number) in a first image, and the cookware items in a second image may also be identified. FIG. 3 illustrates an example approach for matching cookware items, e.g., pots, captured in a sequence of images. At step 305, a previous list of detected and identified pots is accessed. If the number of previously detected pots N is greater than the number of currently detected pots K, then at step 310 a matching criteria, such as a cost function, is used to determine the optimal set of matches. For example, as illustrated in steps 310 and 312, a cost function may be evaluated with respect to each possible set of matches, and the lowest-cost set of matches may be selected. Then, in step 314, the pot or pots from the previous list that were not matched (N being greater than K, in this example) may be identified for removal from the tracked list of detected pots, for example by removing that pot or pots to a list of removed pots. Then, at step 340, the pots identified in the previous image frame(s) are matched with the pots identified from the subsequent image frame(s). The current list of identified pots may then be used as the previous list of identified pots for a subsequent iteration of the matching process.

If the number of previously detected pots is less than the number of currently detected pots, then at step 320 a matching criteria, such as a cost function, is used to determine the optimal set of matches. For example, as illustrated in steps 320 and 322, a cost function may be evaluated with respect to each possible set of matches, and the lowest-cost set of matches may be selected. Then, in step 324, the pot or pots from the current list that were not matched (N being less than K, in this example) may be identified as pots that are newly introduced for the current cooking episode. Then, at step 340, the pots identified in the previous image frame(s) are matched with the pots identified from the subsequent image frame(s). The current list of identified pots may then be used as the previous list of identified pots for a subsequent iteration of the matching process.

If the number of previously detected pots is equal to the number of currently detected pots, then at step 330 a matching criteria, such as a cost function, is used to determine the optimal set of matches. For example, as illustrated in steps 330 and 332, a cost function may be evaluated with respect to each possible set of matches, and the lowest cost set of matches may be selected. Then, at step 340, the pots identified in the previous image frame(s) are matched with the pots identified from the subsequent image frame(s). The current list of identified pots may then be used as the previous list of identified pots for a subsequent iteration of the matching process.

As explained above with respect to step 340 of example of FIG. 3, the output of the matching procedure is a mapping that relates the entries of a current detected pot list to the entries in the previously detected pots list. While the above examples with respect to FIG. 3 illustrate the matching procedure in the context of matching pots, this disclosure contemplates that a matching procedure may be used to match any suitable cookware items. In particular embodiments, matching may be performed by analyzing consecutive pairs of frames received from a camera, with matching then being performed at half the frame rate of the camera. In particular embodiments, matching may be performed at longer intervals, e.g., depending on the available hardware to perform the matching procedures. For example, in particular embodiments, matching may be performed 8-10 times per second. More generally, some or all of the steps of a method for detecting and tracking cookware items on a cooking surface, such as the example method of FIG. 1, may be limited to a lower frame rate than that associated with a camera. For example, the steps of locating and tracking a cookware item, and/or the step of extracting metadata about the cookware item, may be performed at a frequency that is lower than the framerate of the camera. In particular embodiments, the framerate of one or more steps may be based on available computational resources and/or on competing processes performed by the system. For example, some or all of the steps of the example of FIG. 1 may typically occur at, e.g., 20 frames per second, but may be reduced to less than 20 frames per second when the system streams a video to a connected display device in order to ensure the framerate of the streamed video.

As discussed above, particular embodiments may use a cost function to perform cookware matching, such as pot matching. This disclosure contemplates that the cost function can take many forms to accommodate different types of data that can be obtained when identifying a cookware item, such as for example the metadata discussed above. As one example, a cost function may be based on minimizing a sum of squared differences between data in the previous list of cookware and corresponding data in the current list of cookware. For example, for a cookware item such as a pot, temperature may be used as at least part of a cost function used to match pots from a previous list to pots to a current list. For example, if in the previous list pot P1 was associated with a temperature of 56 degrees Celsius and P2 was associated with a temperature of 76 degrees, and in the current list pot C1 is associated with a temperature of 73 degrees and pot C2 is associated with a temperature of 58 degrees, then matching pot P1 with C2 and P2 with C1 would minimize the sum of squared differences based on temperature. As another example, the distance between cookware items, such as pots, may be used to match items by minimizing a cost function, such as the sum of squared differences of the distances between items on the previous list and items on the current list. As another example, a predetermined cost may be added to a cost function based on a mismatch between metadata when matching two cookware items. For example, a predetermined cost may be added to a cost function for matching a pot previously determined to be a frying pan with sauce pan or with a pot. The amount of the cost may be based on a degree of mismatch involved. For example, matching an item previously classified as a “frying pan” with an item currently classified as a “sauce pan” may result in a cost of 10, while matching an item previously classified as a “frying pan” with an item currently classified as a “pot” may result in a cost of 40, and matching an item previously classified as a “sauce pan” with an item currently classified as a “pot” may result in a cost of 30.

In particular embodiments, once matching has been performed, data about cookware items may be updated based on the data subsequently determined about that cookware item. For example, temperature information associated with a particular pot may be updated to reflect new temperature information. In particular embodiments, to prevent jitter in detected values (especially at higher frame rates or low resolutions), a low-pass filter can be used to smooth the data. Any suitable low-pass filter systems can be used, and one example is an exponential averaging filter or sliding window average for updating numerical values, e.g., where the updated value=old_value*alpha+new_value*(1−alpha), where alpha is a value between 0 and 1. For categorical data, particular embodiments may use a sliding window applied to a buffer of historical values for that variable. Then the output value is the categorical value which shows up most frequently in the buffer.

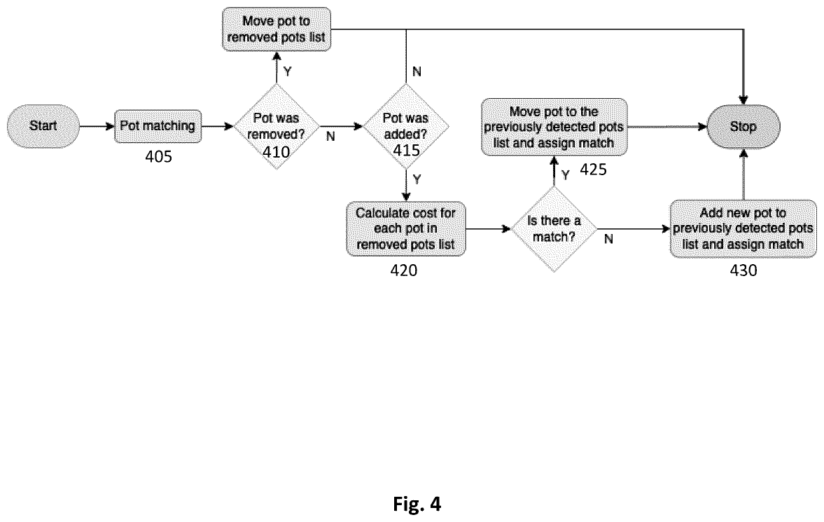

In particular embodiments, if a cookware item such as a pot is entirely removed from the field of view of a camera, then that cookware item may be removed from the main list of cookware items being tracked for the cooking episode, and that cookware item may be added to a secondary, removed-cookware items list, such as for example as discussed above in connection with the example of FIG. 3. FIG. 4 illustrates an example approach for handling removal of cookware items from the field of view or adding cookware items to the field of view, using pots as an example. In the example of FIG. 4, after pot matching is performed in step 405, then determination 410 determines whether a pot was removed from the field of view. If yes, then the pot is added to the removed pots lists. If not, then determination 415 determines whether a pot was added to the field of view. The removal or addition of pots from the field of view may be determined, for example, by comparing two or more captured image frames or by tracking the motion of an object across a sequence of image frames.

If a pot was added to the field of view, then step 420 calculates a cost for matching the added pot to each pot in the removed pots list. If there is a match, e.g., if the cost for the lowest match is below a threshold matching cost, then step 425 may include adding the pot to the previously detected pots list for the next matching iteration and removing the pot from the removed pots list. If there is no match, as determined based on the cost, then step 430 may include adding the new pot to the previously detected pots list.

In particular embodiments, after cookware items are detected and matched, then temporal analysis can be applied to extract and identify cooking events from the images. For example, the system may use a buffer of cookware images, e.g., images of pots, that consist of cropped versions of the cookware item from the previous frames. These cropped images may be provided to an event buffer used to detect cooking events by comparing images in the event buffer. In particular embodiments, the cropped images may be 4-channel (RGB, thermal) images, and features may be extracted from these images, e.g., by using a convolutional neural network, which may then pass the features to a recurrent neural network. Image features may be selected by a sliding window and/or sampling of the images in the buffer. For example, a set of consecutive images in the event buffer may be used to extract and detect events. As another example, images may be sampled (e.g., every Nth image may be sampled, e.g., where N is 2, or an image may be selected every X seconds). In particular embodiments, rather than using a CNN followed by an RNN, a CNN may be used with 3D convolutional layers, which applies convolutions across the time dimension in addition to two spatial dimensions. In this approach, a sliding window and sampling system may be implemented as discussed above, but instead of extracting CNN features to pass into an RNN, the images are stacked into a tensor and passed into the 3D CNN. In particular embodiments, a new event determination may be performed each time a new image is placed into the event buffer, using the sliding or sampling procedures discussed above.

In particular embodiments, event detection may be based on training a machine-learning model, such as the CNN followed by RNN discussed above. This disclosure contemplates that any suitable event may be detected, e.g., based on the event features. For example, events may include a “stir” event, an “add ingredient” event, a “heating” event, or the like. In particular embodiments, as explained below, additional data may be associated with an event, such as the length of time of an event.

In particular embodiments, cookware tracking and event detection may be used to automatically generate recipes for a user. For example, while a user is cooking (e.g., when activity is occurring during a cooking episode), then the system may detect events and determine whether the events correspond to recipe events, such as adding an ingredient or stirring contents of a pot. Data about the event, such as the particular ingredient added, an amount of ingredient added, the temperature of a pot at the time the ingredient was added, etc. may be associated with the detected event and saved in an event catalog along with a timestamp of the event. At the end of the cooking episode, a step description or label can be generated (using either template text, or via an NLP model) for each event. In particular embodiments, one or more images taken by a camera during the detected event can be selected as an image to display along with the recipe step. Finally, the generated recipe can be saved in machine-readable and human-readable formats, then shared to the user and/or uploaded to, e.g., a recipe database.

While some of the examples above utilize trained machine-learning models to detect events, this disclosure contemplates that other approaches to event detection may be used. For example, motion may be detected from a sequence of images, and when the motion exceeds a motion threshold, then an event may be saved, along with a timestamp and any suitable additional data such as an image of the event. Then, at the end of a cooking episode, the events may be provided to a user to label, and additional text may be generated either automatically or by a user. The sequence of detected events as modified (e.g., if the user has additions or deletions) and described by a user may then be saved as an automatically generated recipe.

In particular embodiments, a detected event may be compared to an expected event from, e.g., a recipe. For example, a user may upload a particular recipe the user intends to follow, or the system may automatically identify a recipe based on, e.g., the events already detected. Therefore, an expected event may be a current step of a recipe that a user is following. If a detected event matches an expected event, then the system may advance the recipe to the next step and provide a notification to the user, as explained more fully herein. For example, if the detected event is a stir event, which matches the expected event, then the recipe may be advanced to the next step, which may be a length of time that stirring is supposed to happen. As another example, if the detected event is an add ingredient event and the correct ingredient was added, then the recipe may be advanced to the next step, which may be to add another ingredient, adjust the heat, move a pot, etc. In particular embodiments, upon correct event matching the system may start a timer until the next step is to be performed, if time is supposed to lapse between steps, according to the recipe. In particular embodiments, if a detected event does not match the expected step, then a notification may be provided to the user, which the user may override.

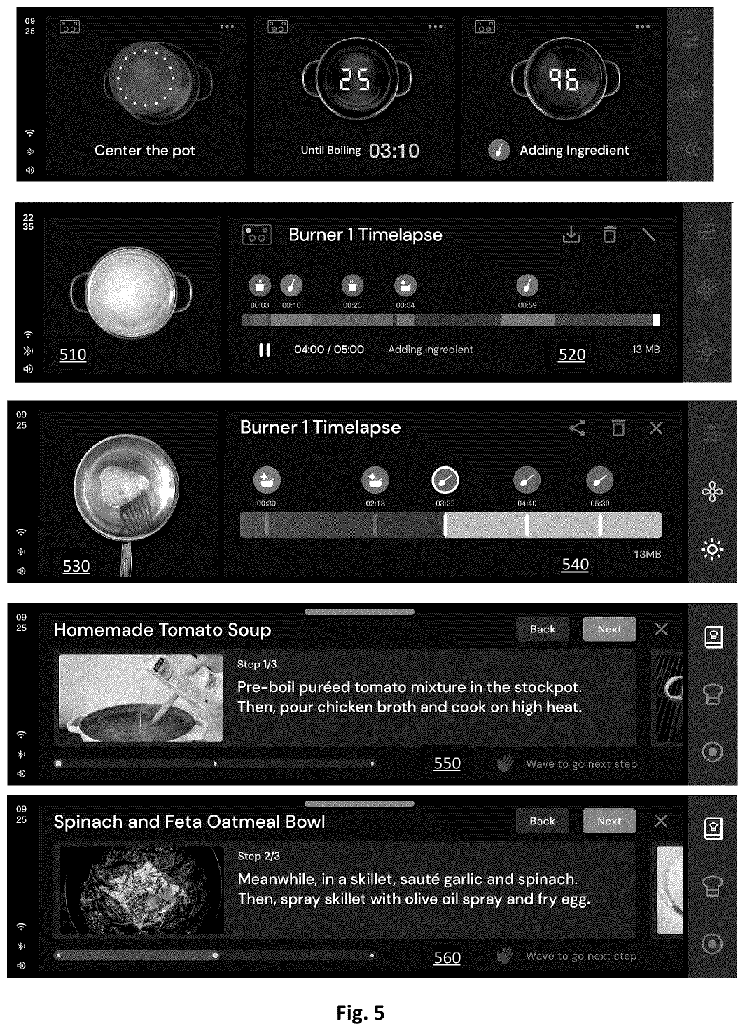

FIG. 5 illustrates examples of user interfaces that illustrate aspects of providing feedback to a user. In particular embodiments, all or some of these UIs may be provided on a display that is integrated with cameras and hardware, for example integrated in a range hood. In particular embodiments, all or some of this UI may be provided for display on a connected computing device, such as on a smartphone, TV, tablet, smartwatch, etc.

In particular embodiments, a UI may include a current image captured by one or more cameras, such as for example an image of a pot shown in region 510 of the example UI. A UI may include a timeline, such as shown in region 520 of the UI, which may correspond to a recipe the user following. As shown in the example of FIG. 5, region 520 includes a textual description of the next step and an interactive element that the user can use to pause the recipe. As shown in FIG. 5, region 520 may also display an overview of the recipe, e.g., using icons that correspond to recipe steps, identifiers of the length of time associated with each step, and a color-coded bar that identifies the length of time between steps, as illustrated in FIG. 5. Regions 530 and 540 illustrate another embodiment of these aspects of a UI.

In particular embodiments, a UI may provide cooking-related information to a user. For example, the UI may provide an instruction to the user based on the detected cookware items, such as for example an instruction to center a pot on a burner or remove a pot that is too hot or boiling over. As another example, the UI may provide feedback to a user regarding the status of cookware items, such as that a pot has been boiling for a certain length of time, and/or the current temperature of the contents of the pot and the location of the pot on a range. As another example, UI elements 550 and 560 illustrate example interfaces for providing recipe-related instructions to a user. As illustrated in the example of UI elements 550 and 560, the instructions may be accompanied by one or more images related to the instructions, and may include an instruction for an interaction (e.g., waving to move one step forward) that enables the user to navigate the instruction sequence. In addition or in the alternative to a UI such as the example UI of FIG. 5, notifications may be provided to a user's computing device. For example, cooking-related notifications such as detected events or recipe instructions may be pushed to a user's connected smartphone or smartwatch. In addition or the alternative, audio notifications such as automated reading of recipe instructions may be provided to a user using, for example, a connected computing device or an integrated speaker.

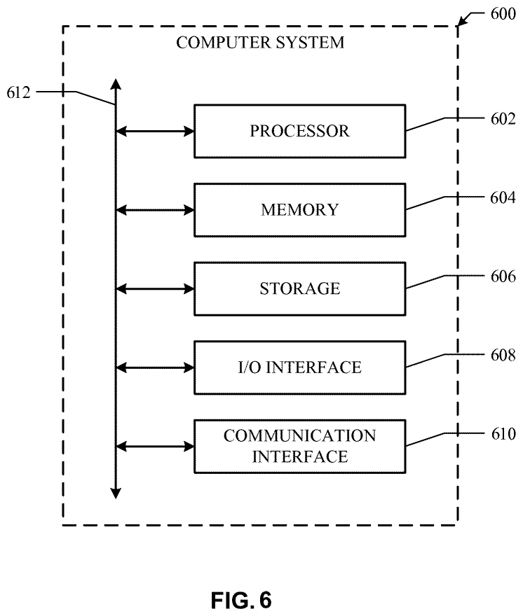

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates particular components, devices, or systems carrying out particular steps of the method of FIG. 1, such as the computer system of FIG. 6, this disclosure contemplates any suitable combination of any suitable components, devices, or systems carrying out any suitable steps of the method of FIG. 1. Moreover, this disclosure contemplates that some or all of the computing operations described herein, including the steps of the example method illustrated in FIG. 1, may be performed by circuitry of a computing device, for example the computing device of FIG. 6, by a processor coupled to non-transitory computer readable storage media, or any suitable combination thereof.

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing an image of a cooking surface, wherein the image is associated with a field of view that includes the cooking surface;
identifying, based at least on the image, one or more cookware items within the field of view;
associating a unique identifier with each identified cookware item in the field of view; and
tracking, using one or more subsequent images of the cooking surface, a location of each of the one or more cookware items relative to the cooking surface.

2. The method of claim 1, further comprising:
accessing an optical image comprising an RGB image or grayscale image of the cooking surface;
accessing a thermal image of the cooking surface;
removing distortion in each of the optical image and the thermal image; and
aligning the optical image and the thermal image to produce the accessed image of the cooking surface.

3. The method of claim 2, further comprising:
detecting one or more features in the accessed image of the cooking surface; and
identifying, based on the detected image features, the one or more cookware items; and
associating with the unique identifier the location of the cookware item relative to the cooking surface.

4. The method of claim 3, further comprising associating with the unique identifier a size of the cookware item.

5. The method of claim 1, further comprising:
creating, based on the identified one or more cookware items from the image, a prior list of previous cookware items present in the field of view; and
creating, based on at least one of the one or more subsequent images, a current list of current cookware items present in the field of view.

6. The method of claim 5, wherein the cookware items comprise pots, the method further comprising:
when a number of pots in the prior list is equal to a number of pots in the current list, then matching each pot in the current list to a pot in the prior list.

7. The method of claim 6, wherein the pot matching comprises determining a set of matches that has the lowest cost according to a cost function.

8. The method of claim 5, wherein the cookware items comprise pots, the method further comprising:
when a number of pots in the current list is less than a number of pots in the current list, then matching each pot in the current list to a pot in the prior list; and
for each pot in the prior list that is not matched to a pot in the current list, then adding that unmatched pot to a list of removed pots.

9. The method of claim 8, wherein matching each pot in the current list to a pot in the prior list comprises determining a set of matches that has the lowest cost according to a cost function.

10. The method of claim 5, wherein the cookware items comprise pots, the method further comprising:
when a number of pots in the prior list is less than a number of pots in the current list, then matching each pot in the prior list to a pot in the current list; and
for each pot in the current list that is not matched to a pot in the prior list, then adding that unmatched pot to a list of new pots.

11. The method of claim 10, further comprising, for each pot in the list of new pots:
comparing that pot to each pot in a list of removed pots to determine whether to match that pot to a pot in the list of removed pots; and
in response to a determination that the pot matches a pot in the list of removed pots, then matching that pot to a list of all pots detected during a cooking episode; or
in response to a determination that the pot does not match a pot in the list of removed pots, then adding an identification of the pot to the list of all pots detected during the cooking episode.

12. The method of claim 1, further comprising:
accessing a temporal sequence of images of the cooking surface;
determining, based on the temporal sequence, whether a cooking event has occurred.

13. The method of claim 12, further comprising:
in response to a determination that a cooking event has occurred, then logging the event in an automatically generated recipe.

14. The method of claim 13, further comprising:
determining, for each event, at least one of a timestamp of the event or a duration of the event; and
logging, with the event in the automatically generated recipe, the determined timestamp of the event or the determined duration of the event, or both.

15. The method of claim 12, further comprising providing feedback to a user regarding a comparison of a detected cooking event to an expected cooking event, wherein the expected cooking event is an event from a recipe.

16. The method of claim 12, further comprising providing feedback to a user regarding a detected cooking event.

17. The method of claim 16, wherein the feedback comprises an identification of the detected cooking event in the context of a timeline of a plurality of predetermined cooking events.

18. The method of claim 16, wherein the feedback comprises:
an instruction to adjust one or more of the cookware items; or
an instruction to adjust a setting associated with the cooking surface.

19. A system comprising one or more processors and a non-transitory computer readable storage media embodying instructions coupled to the one or more processors, the one or more processors operable to execute the instructions to:
access an image of a cooking surface, wherein the image is associated with a field of view that includes the cooking surface;
identify, based at least on the image, one or more cookware items within the field of view;
associate a unique identifier with each identified cookware item in the field of view; and
track, using one or more subsequent images of the cooking surface, a location of each of the one or more cookware items relative to the cooking surface.

20. One or more non-transitory computer readable storage media embodying instructions and coupled to one or more processors that are operable to execute the instructions to:
access an image of a cooking surface, wherein the image is associated with a field of view that includes the cooking surface;
identify, based at least on the image, one or more cookware items within the field of view;
associate a unique identifier with each identified cookware item in the field of view; and
track, using one or more subsequent images of the cooking surface, a location of each of the one or more cookware items relative to the cooking surface.
